(19) United States
(12) Patent Application Publication
(10) Pub. No.: US 2026/0292615 A1
(43) Pub. Date: Sep. 24, 2026

(54) Enhancements for Non-Collocated Carrier Aggregation

(71) Applicant: Apple Inc., Cupertino, CA (US)

(72) Inventors: Rolando E Bettancourt Ortega, Munich (DE); Yang Tang, San Jose, CA (US); Yuexia Song, Beijing (CN); Jie Cui, San Jose, CA (US); Qiming Li, Beijing (CN); Xiang Chen, Palo Alto, CA (US)

(21) Appl. No.: 19/472,602

(22) PCT Filed: Apr. 6, 2023
(86) PCT No.: PCT/CN2023/086492

§ 371 Date: Oct. 3, 2025

(51) Int. Cl. H04W 36/00; H04B 17/318; H04L 5/00

(52) U.S. Cl. CPC H04W 36/00692; H04B 17/328; H04L 5/0007

(57) ABSTRACT

Apparatuses, systems, and methods for enhanced non-collocated carrier aggregation in cellular systems, e.g., in LTE systems, 5G NR systems, and beyond. A method may include establishing a cellular link with a network node and transmitting signaling including capability information indicating support of carrier aggregation (CA) of a first component carrier (CC) and a second CC. The method may further include receiving physical downlink shared channel (PDSCH) signaling on the first and second CCs and measuring a relative time difference (RTD) between the first CC and the second CC. The method may also include transmitting, to the network node, a report including the measured RTD and receiving, from the network node, first downlink (DL) signaling on the first CC and second DL signaling on the second CC. One of the first DL signaling or second DL signaling may include an adjusted set of OFDM symbols which are adjusted based on the measured RTD such that a degraded OFDM symbol is avoided.

### FIELD

The invention relates to wireless communications, and more particularly to apparatuses, systems, and methods for enhanced non-collocated carrier aggregation in cellular systems, e.g., in LTE systems, 5G NR systems, and beyond.

### DESCRIPTION OF THE RELATED ART

Wireless communication systems are rapidly growing in usage. In recent years, wireless devices such as smart phones, wearable devices or accessory devices), and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies. Accordingly, improvements in the field are desired.

### SUMMARY

Embodiments relate to wireless communications, and more particularly to apparatuses, systems, and methods for enhanced non-collocated carrier aggregation in cellular systems, e.g., in LTE systems, 5G NR systems, and beyond.

In some embodiments, a method may include establishing a cellular link with a network node and transmitting, to the network node, signaling including capability information indicating support of carrier aggregation (CA) of a first component carrier (CC) and a second CC. The method may further include receiving, from the network node, physical downlink shared channel (PDSCH) signaling on the first and second CCs and measuring a relative time difference (RTD) between a start of a first orthogonal frequency division multiplex (OFDM) symbol in a current slot of the first CC and a start of a first OFDM symbol in a current slot of the second CC. Alternatively, the method may include measuring an RTD between a start of a first OFDM symbol in a current slot of the first CC and an end of a last OFDM symbol in a previous slot of the second CC. The method may also include transmitting, to the network node, a report including the measured RTD and receiving, from the network node, first downlink (DL) signaling on the first CC and second DL signaling on the second CC. According to some embodiments, one of the first DL signaling or second DL signaling may include an adjusted set of OFDM symbols. Additionally or alternatively, the adjusted set of OFDM symbols may be adjusted at least partially based on the measured RTD such that a degraded OFDM symbol is avoided.

According to some instances, the method may further include determining a measurement reference point of the first CC or the second CC. Additionally, the measurement reference point may correspond to a CC which is the other of the one of the first CC or second CC associated with the adjusted set of OFDM symbols, according to some embodiments. In some embodiments, the determination may be based on one or more reference signal received power (RSRP) metrics, one or more reference signal received quality (RSRQ) metrics, one or more maximum average aggregate throughput metrics associated with the first and second CCs. In some embodiments, the determination may be based on which of the first CC or the second CC is associated with a primary cell (PCell). Additionally or alternatively, the determination may be at least partially based on an indication received from the network node.

In some embodiments, the measured RTD may be less than or equal to a maximum receive timing difference (MRTD) and the MRTD may be greater than a cyclic prefix (CP). Accordingly, when the measured RTD is less than or equal to the MRTD, the UE may be capable of supporting an increased power imbalance between the first CC and the second CC. According to further embodiments, the method may include determining, based on the measured RTD, a degraded OFDM symbol associated with either the first CC or the second CC. In some embodiments, the degraded OFDM symbol may be corrupted due a phase jump when an analog gain change does not occur at the beginning of at least one of the first CC or the second CC. In some embodiments, the method may be performed by a Type 3a user equipment (UE) or a Type 3b UE.

In some embodiments, a method may include establishing a radio resource control (RRC) connection with a user equipment (UE) and receiving, from the UE, signaling including capability information indicating support of carrier aggregation (CA) of a first component carrier (CC) and a second CC. The method may further include transmitting, to the UE, physical downlink shared channel (PDSCH) signaling on the first and second CCs and receiving, from the UE, a report comprising a measured relative time difference (RTD). In some embodiments, the measured RTD may be an RTD between a start of a first orthogonal frequency division multiplex (OFDM) symbol in a current slot of the first CC and a start of a first OFDM symbol in a current slot of the second CC or an RTD between a start of a first OFDM symbol in a current slot of the first CC and an end of a last OFDM symbol in a previous slot of the second CC. The method may further include comparing the measured RTD to one or more signaling metrics associated with the first and second CCs and transmitting, to the UE, transmitting, to the UE, first downlink (DL) signaling on the first CC and second DL signaling on the second CC. According to some embodiments, one of the first DL signaling or second DL signaling may include an adjusted set of OFDM symbols. Additionally or alternatively, the adjusted set of OFDM symbols may be adjusted to avoid a degraded OFDM symbol and may be at least partially based on the comparison of the measured RTD to the one or more signaling metrics.

According to further embodiments, the method may include transmitting, to the UE, signaling including an indication of an alignment of a shared low noise amplifier (LNA) with either the first CC or the second CC. Additionally or alternatively, the method may include configuring, for reception of a physical downlink control channel (PDCCH), at least one control resource set (CORESET) located after the first OFDM symbol. In some embodiments, the comparison of the RTD to one or more signaling metrics may be performed according to the inequality that the measured RTD is less than a cyclic prefix (CP) which is less than X microseconds (μs), where X is value which may correspond to a maximum receive timing difference (MRTD). Additionally or alternatively, the comparison of the RTD to one or more signaling metrics may be performed according to the inequality that the CP is less than the measured RTD which is less than X μs. In some embodiments, the comparison of the RTD to one or more signaling metrics may be performed according to the inequality that the measured RTD is greater than X μs.

In some embodiments, if the measured RTD is less than the CP which is less than X μs, the method may further include scheduling the adjusted PDSCH signaling using available symbols in a slot (e.g., in the range from sym0-sym13). Additionally or alternatively, if the CP is less than the measured RTD which is less than X μs, the method may further include scheduling the adjusted PDSCH signaling using symbols in the range from sym1-sym13 range or symbols in the range from sym0-sym12 (e.g., excluding the first or last symbol in the slot of one of the CCs). In some embodiments, if the measured RTD greater than X μs, the method may further include refraining from scheduling the adjusted PDSCH signaling. According to further embodiments, a maximum of four multiple input multiple output (MIMO) layers may be supported on the first CC and/or the second CC.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates a communication flow diagram of an example method for enhanced non-collocated carrier aggregation, according to some embodiments.

FIGS. 7A and 7B illustrate example aspects of enhanced non-collocated carrier aggregation including relative time difference measurements, according to some embodiments.

FIGS. 8-10 illustrate example aspects of enhanced non-collocated carrier aggregation related to dynamic PDSCH scheduling, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
DL: Downlink
UL: Uplink
LTE: Long Term Evolution
NR: New Radio
5GS: 5G System
5GMM: 5GS Mobility Management
5GC/5GCN: 5G Core Network
gNB: Next Generation Node-B
RS: Reference Signal
CC: Component Carrier
TRP: Transmission and Reception Point
CA: Carrier Aggregation
MRTD: Maximum Receive Timing Difference
CP: Cyclic Prefix
RTD: Relative Time Difference
OFDM: Orthogonal Frequency Division Multiplex
PDSCH: Physical Downlink Shared Channel
PDCCH: Physical Downlink Control Channel
SSB: Synchronization Signal Block
PBCH: Physical Broadcast Channel
CSI-RS: Channel State Information-Reference Signal
TRS: Total Radiated Sensitivity
LNA: Low Noise Amplifier
RSRP: Reference Signal Received Power
RSRQ: Reference Signal Received Quality
Pcell: Primary Cell
Scell: Secondary Cell
FDD: Frequency Division Duplex
TDD: Time Division Duplex
CORESET: Control Resource Set
DM-RS: Demodulation Reference Signal

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

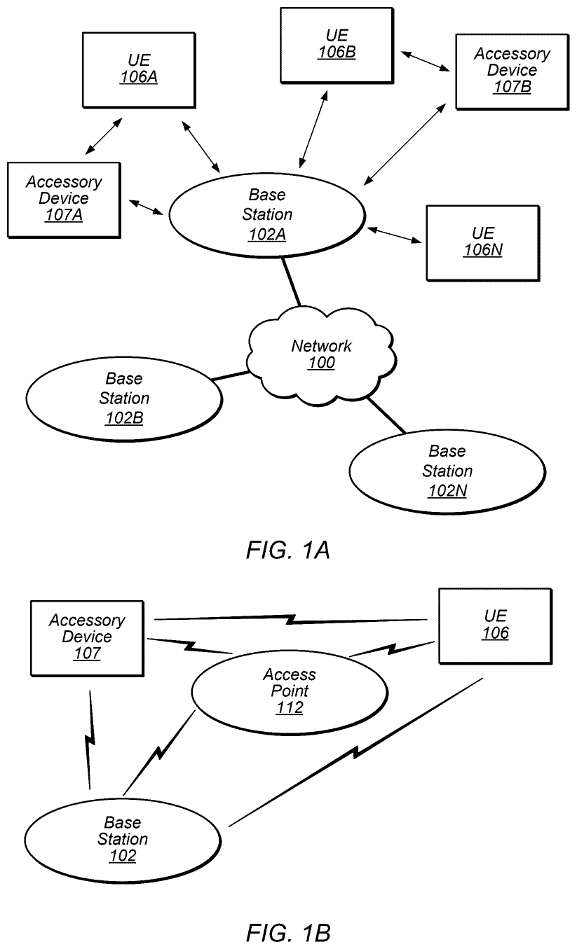

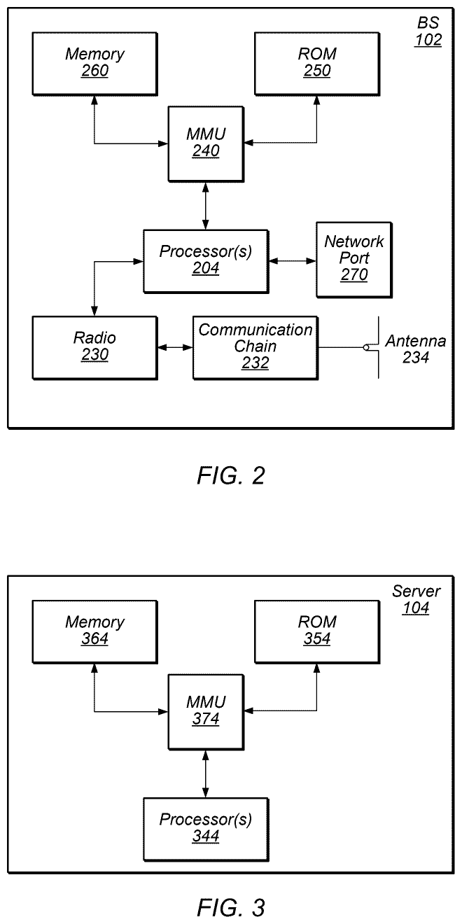

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more wireless devices, such as user devices 106A, 106B, etc., through 106N, as well as accessory devices, such as user devices 107A, 107B. Each of the user devices may be referred to herein as a “user equipment” (UE). Thus, the user devices 106 and 107 are referred to as UEs or UE devices.

The base station (BS) 102A may be a base transceiver station (BTS) or cell site (a “cellular base station”) and may include hardware that enables wireless communication with the UEs 106A through 106N as well as UEs 107A and 107B.

The communication area (or coverage area) of the base station may be referred to as a “cell.” The base station 102A and the UEs 106/107 may be configured to communicate over the transmission medium using any of various radio access technologies (RATs), also referred to as wireless communication technologies, or telecommunication standards, such as UMTS (associated with, for example, WCDMA or TD-SCDMA air interfaces), LTE, LTE-Advanced (LTE-A), 5G new radio (5G NR), HSPA, etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106/107 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106/107 as illustrated in FIG. 1, each UE 106/107 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106/107 may be capable of communicating using multiple wireless communication standards. For example, the UE 106/107 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., UMTS (associated with, for example, WCDMA or TD-SCDMA air interfaces), LTE, LTE-A, 5G NR, HSPA, etc.). The UE 106/107 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Note that accessory devices 107A/B may include cellular communication capability and hence are able to directly communicate with cellular base station 102A via a cellular RAT. However, since the accessory devices 107A/B are possibly one or more of communication, output power, and/or battery limited, the accessory devices 107A/B may in some instances selectively utilize the UEs 106A/B as a proxy for communication purposes with the base station 102A and hence to the network 100. In other words, the accessory devices 107A/B may selectively use the cellular communication capabilities of its companion device (e.g., UEs 106A/B) to conduct cellular communications. The limitation on communication abilities of the accessory devices 107A/B may be permanent, e.g., due to limitations in output power or the RATs supported, or temporary, e.g., due to conditions such as current battery status, inability to access a network, or poor reception.

FIG. 1B illustrates user equipment 106 (e.g., one of the devices 106A through 106N) and accessory device (or user equipment) 107 (e.g., one of the devices 107A or 107B) in communication with a base station 102 and an access point 112 as well as one another, according to some embodiments. The UEs 106/107 may be devices with both cellular communication capability and non-cellular communication capability (e.g., Bluetooth, Wi-Fi, and so forth) such as a mobile phone, a wearable device, a hand-held device, a computer or a tablet, or virtually any type of wireless device. The accessory device 107 may be a wearable device such as a smart watch. The accessory device 107 may comprise cellular communication capability and be capable of directly communicating with the base station 102 as shown. Note that when the accessory device 107 is configured to directly communicate with the base station, the accessory device may be said to be in “autonomous mode.” In addition, the accessory device 107 may also be capable of communicating with another device (e.g., UE 106), referred to as a proxy device, intermediate device, or companion device, using a short-range communications protocol; for example, the accessory device 107 may according to some embodiments be “paired” with the UE 106, which may include establishing a communication channel and/or a trusted communication relationship with the UE 106. Under some circumstances, the accessory device 107 may use the cellular functionality of this proxy device for communicating cellular voice and/or data with the base station 102. In other words, the accessory device 107 may provide voice and/or data packets intended for the base station 102 over the short-range link to the UE 106, and the UE 106 may use its cellular functionality to transmit (or relay) this voice and/or data to the base station on behalf of the accessory device 107. Similarly, the voice and/or data packets transmitted by the base station and intended for the accessory device 107 may be received by the cellular functionality of the UE 106 and then may be relayed over the short-range link to the accessory device. As noted above, the UE 106 may be a mobile phone, a tablet, or any other type of hand-held device, a media player, a computer, a laptop or virtually any type of wireless device. Note that when the accessory device 107 is configured to indirectly communicate with the base station 102 using the cellular functionality of an intermediate or proxy device, the accessory device may be said to be in “relay mode.”

The UE 106/107 may include a processor that is configured to execute program instructions stored in memory. The UE 106/107 may perform any of the method embodiments described herein by executing such stored instructions. Alternatively, or in addition, the UE 106/107 may include a programmable hardware element such as an FPGA (field-programmable gate array) that is configured to perform any of the method embodiments described herein, or any portion of any of the method embodiments described herein.

The UE 106/107 may include one or more antennas for communicating using one or more wireless communication protocols or technologies. In some embodiments, the UE 106 may be configured to communicate using, for example, LTE/LTE-Advanced, or 5G NR using a single shared radio and/or LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106/107 may share one or more parts of a receive and/or transmit chain between multiple wireless communication technologies, such as those discussed above.

In some embodiments, the UE 106/107 may include separate transmit and/or receive chains (e.g., including separate antennas and other radio components) for each wireless communication protocol with which it is configured to communicate. As a further possibility, the UE 106/107 may include one or more radios which are shared between multiple wireless communication protocols, and one or more radios which are used exclusively by a single wireless communication protocol. For example, the UE 106/107 might include a shared radio for communicating using either of LTE or 5G NR (or LTE or 1×RTT or LTE), and separate radios for communicating using each of Wi-Fi and Bluetooth. Other configurations are also possible.

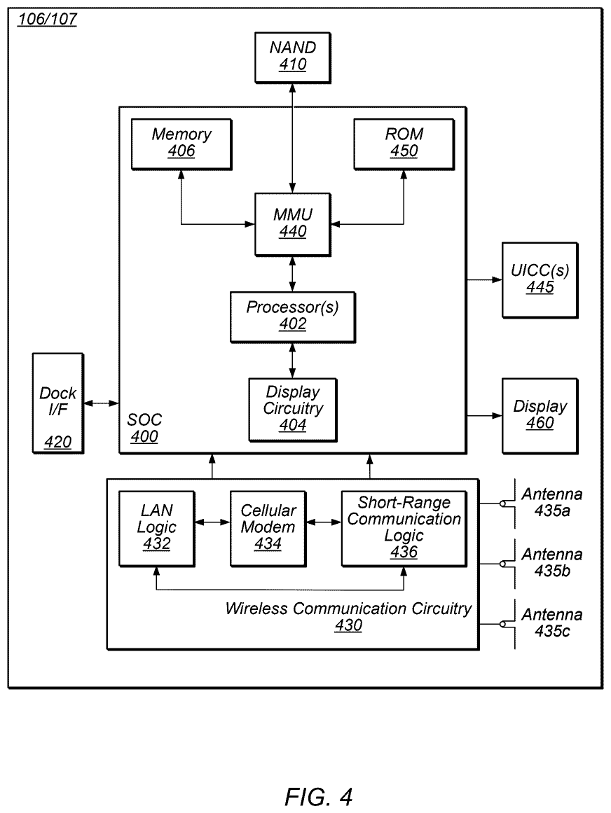

### FIG. 2: Block Diagram of a Base Station

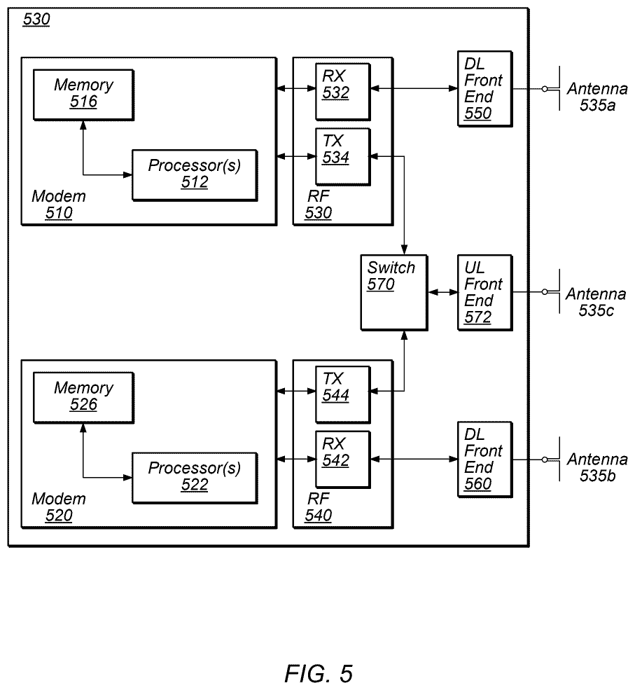

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, UMTS, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and UMTS, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (Ics) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (Ics) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (Ics) that are configured to perform the functions of processor(s) 344. In addition, each integrated circuit may include circuitry (e.g., first circuitry, second circuitry, etc.) configured to perform the functions of processor(s) 344.

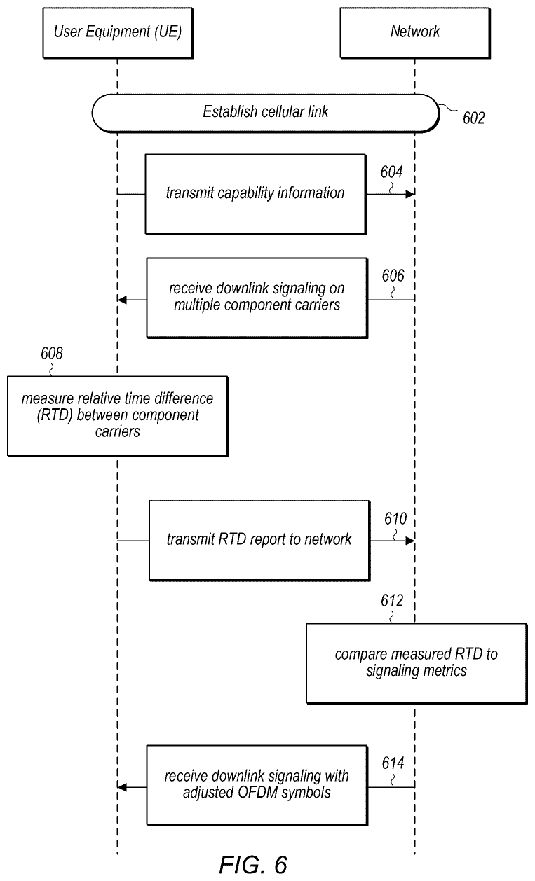

### FIG. 4: Block Diagram of a UE

FIG. 4 illustrates an example simplified block diagram of a communication device 106/107, according to some embodiments. It is noted that the block diagram of the communication device of FIG. 4 is only one example of a possible communication device. According to embodiments, communication device 106/107 may be a user equipment (UE) device, a mobile device or mobile station, a wireless device or wireless station, a desktop computer or computing device, a mobile computing device (e.g., a laptop, notebook, or portable computing device), a wearable device, a tablet, an unmanned aerial vehicle (UAV), a UAV controller (UAC) and/or a combination of devices, among other devices. As shown, the communication device 106/107 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106/107 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106/107, and wireless communication circuitry 430. The wireless communication circuitry 430 may include a cellular modem 434 such as for 5G NR, LTE, etc., and short to medium range wireless communication logic 436 (e.g., Bluetooth™ and WLAN circuitry). In some embodiments, communication device 106/107 may include wired communication circuitry (not shown), such as a network interface card, e.g., for Ethernet.

The wireless communication circuitry 430 may couple (e.g., communicatively; directly or indirectly) to one or more antennas, such as antennas 435a, 435b, and 435c (e.g., 435a-c) as shown. The wireless communication circuitry 430 may include local area network (LAN) logic 432, the cellular modem 434, and/or short-range communication logic 436. The LAN logic 432 may be for enabling the UE device 106/107 to perform LAN communications, such as Wi-Fi communications on an 802.11 network, and/or other WLAN communications. The short-range communication logic 436 may be for enabling the UE device 106/107 to perform communications according to a short-range RAT, such as Bluetooth or UWB communications. In some scenarios, the cellular modem 434 may be a lower power cellular modem capable of performing cellular communication according to one or more cellular communication technologies.

In some embodiments, as further described below, cellular modem 434 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular modem 434 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106/107 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106/107 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106/107 may include at least two SIMs. Each SIM may execute one or more SIM applications and/or otherwise implement SIM functionality. Thus, each SIM may be a single smart card that may be embedded, e.g., may be soldered onto a circuit board in the UE 106/107, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106/107 may include a combination of removable smart cards and fixed/non-removable smart cards (such as one or more eUICC cards that implement eSIM functionality), as desired. For example, the UE 106/107 may comprise two embedded SIMs, two removable SIMs, or a combination of one embedded SIMs and one removable SIMs. Various other SIM configurations are also contemplated.

As noted above, in some embodiments, the UE 106/107 may include two or more SIMs. The inclusion of two or more SIMs in the UE 106/107 may allow the UE 106/107 to support two different telephone numbers and may allow the UE 106/107 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106/107 comprises two SIMs, the UE 106/107 may support Dual SIM Dual Active (DSDA) functionality. The DSDA functionality may allow the UE 106/107 to be simultaneously connected to two networks (and use two different RATs) at the same time, or to simultaneously maintain two connections supported by two different SIMs using the same or different RATs on the same or different networks. The DSDA functionality may also allow the UE 106/107 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106/107 may support Dual SIM Dual Standby (DSDS) functionality. The DSDS functionality may allow either of the two SIMs in the UE 106/107 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for positioning reference signals (PRSs) for reduced capacity devices, e.g., in 5G NR systems and beyond, as further described herein.

As described herein, the communication device 106/107 may include hardware and software components for implementing the above features for a communication device 106/107 to communicate a scheduling profile for power savings to a network. The processor 402 of the communication device 106/107 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (Ics) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (Ics) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more Ics that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

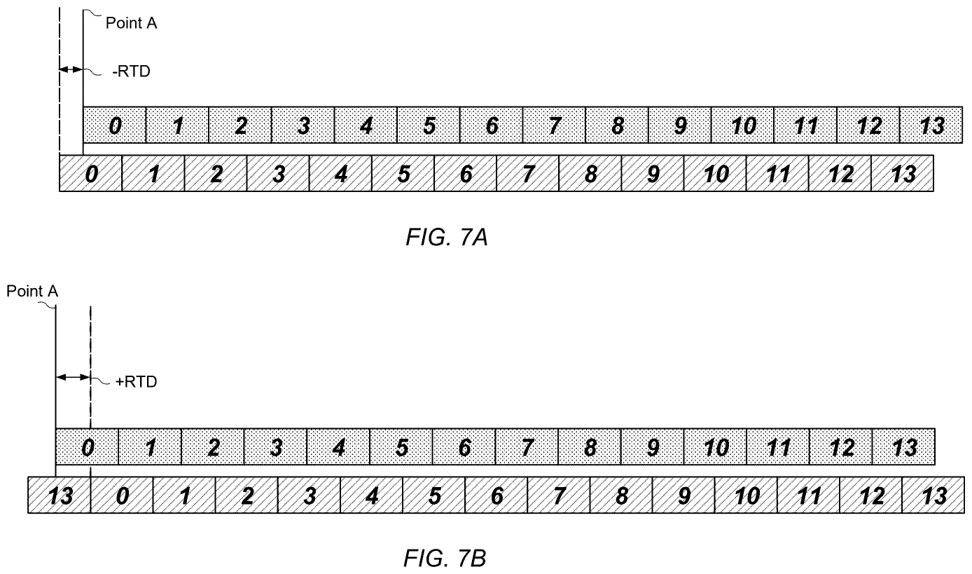

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular modem circuitry 434, may be included in a communication device, such as communication device 106/107 described above. As noted above, communication device 106/107 may be a user equipment (UE) device, a mobile device or mobile station, a wireless device or wireless station, a desktop computer or computing device, a mobile computing device (e.g., a laptop, notebook, or portable computing device), a tablet, a wearable device, and/or a combination of devices, among other devices.

The cellular communication circuitry 530 may couple (e.g., communicatively; directly or indirectly) to one or more antennas, such as antennas 535a-c (which may be antennas 435a-c of FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 535a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 535b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 535c. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods for positioning reference signals (PRSs) for reduced capacity devices, e.g., in 5G NR systems and beyond, as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 535a-c may be configured to implement part or all of the features described herein.

In addition, as described herein, processors 512 may include one or more processing elements. Thus, processors 512 may include one or more integrated circuits (Ics) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for positioning reference signals (PRSs) for reduced capacity devices, e.g., in 5G NR systems and beyond, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 535a-c may be configured to implement part or all of the features described herein.

In addition, as described herein, processors 522 may include one or more processing elements. Thus, processors 522 may include one or more integrated circuits (Ics) that are configured to perform the functions of processors 522. In addition, each integrated circuit may include circuitry (e.g., first circuitry, second circuitry, etc.) configured to perform the functions of processors 522.

### Intra-Band Non-Collocated Carrier Aggregation

Intra-band collocated carrier aggregation (CA) has been discussed and studied recently. More specifically, in intra-band collocated CA, transmit (Tx) antenna collocation has been assumed to ensure that maximum receive timing difference (MRTD) of component carriers is less than a given threshold. However, in some instances, Tx antenna collocation may cost-inefficient or infeasible due to the spectrum range specified for intra-band collocated CA operation. For example, as phased manner spectrum allocation may be associated with a frequency range of 3300~4200 MHz (as one example), there may be insufficient room to collocate later launched Tx antennas in a collocated manner with earlier launched Tx antennas.

However, in non-collocation scenarios, a larger received time difference (RTD) between component carriers may be observed and which may correspond to a larger relative receiving time difference between two signals relatively received on the component carriers. Furthermore, a power imbalance between aggregated component carriers may be increased as compared to collocated CA. In view of this, intra-band non-collocated CA techniques may be refined to provide beneficial enhancements. For example, it may be beneficial to describe a method for enhanced intra-band non-collocated CA such that degraded OFDM symbols (potentially due to CA) may be avoided and therefore efficiency of CA in non-collocated scenarios may be increased. Therefore, new types of scheduling and reporting policies need to be considered for an enhanced support of intra-band non-collocated CA.

In some scenarios, a component carrier (CC) from a base station (e.g., BS 102) may be aggregated with one or more other CCs from at least one other remote radio units (RRUs) or other base stations to increase the bandwidth. Such aggregation of the CCs may be referred to as non-collocated CA due to the non-collocated antennas associated with the BS and RRUs. The CC from the base station and the CC from one or more of the RRUs may belong to the same operating frequency band, such as 3300~4200 MHz. In such a scenario, the aggregation of the CCs may be referred to as intra-band non-collocated CA.

Additionally, and according to some embodiments, the CC from the BS 102 and the CC(s) from one or more of the RRUs may belong to different spectrum blocks. For example, the CC from the base station 102 may belong to a spectrum block in a frequency range of 3900~4000 MHz. Furthermore, the CC from the RRU may belongs to one of spectrum blocks such as 3400~3440 MHz or 3560~3600 MHz. In the case of non-collocated CA, a power imbalance between the CCs supporting the CA may be as large as 25 decibels (dB). Additionally, a larger arrival of time difference may also observed by the UE 106.

Currently, intra-band collocated requirements may be defined for UE only considering 6 dB power imbalance between the aggregated carriers, (e.g., the minimum RF requirement in TS 38.101 and the demodulation performance in TS 38.101). Accordingly, a 6 dB power imbalance may correspond to BS antennas that are very close in distance (e.g., are collocated). However, there may not be a requirement to support intra-band non-collocated CA (e.g., BS antennas that are not very close in distance which may be considered to be non-collocated).

Accordingly, there may be a need to provide methods for enhanced intra-band non-collocated CA scenarios. For example, one possible enhancement may include a UE transmitting capability information about the UE to a BS. The capability information may indicate that the UE supports a set of parameters for aggregation of non-collocated CCs. The BS may then activate, deactivate, or adjust scheduling of the non-collocated CCs based on the capability information. Thus, performance of the non-collocated CA may be improved.

Additionally, intra-band CA may be a cost-effective improvement for operators if one or more antenna collocation conditions were relaxed. For example, in recent studies, at least two issues were observed with regard to intra-band non-collocated CA scenarios. First, a larger power imbalance between component carriers (CCs) was observed to be as large as 25 dB (as one approximate example). Additionally, a larger time arrival difference between CCs was observed by the UE. For example, a maximum receive timing difference (MRTD) was observed to be greater than 3 μs (as one approximate example). Accordingly, new power imbalance and MRTD constraint considerations or requirements may be necessary to implement methods of enhanced intra-band non-collocation CA. Furthermore, new network configurations and physical (PHY) layer scheduling policies may help to maximize aggregate throughput in such scenarios.

Moreover, different types of UEs may need to be considered and reported to the network for scheduling purposes. For example, a Type 1 CA UE may support up to a 6 dB power imbalance between aggregated CCs and support a MRTD of less than or equal to 3 μs (as one example and as described in TS 38.133 and the existing minimum requirements in TS 38.101). As another example, a Type 2 CA UE may support a 25 dB power imbalance between aggregated CCs and a MRTD of less than or equal to 33 μs (as one example and as described in in TS 38.133 and new RF and minimum requirements in TS 38.101). According to some scenarios involving Type 1 and Type 2 UEs a maximum of two MIMO layers may be supported on each CC.

Alternatively, Type 3 UEs may support larger power imbalances between aggregated CCs and MRTDs between 3 μs and 33 μs (as one example and as discussed in TS 38.133 and new RF and minimum requirements in TS 38.101). Furthermore, according to some scenarios involving type 3 UEs, a maximum of four MIMO layers may be supported on each CC. In some embodiments, a Type 3 UE may also be capable of falling back to operate as a type 2 UE depending on the capability.

Additionally, for type 3 UEs, it may be beneficial to constrain the MRTD such that it is greater than (e.g., kept within) the cyclic prefix (CP). While this may limit network deployment in some aspects, keeping the MRTD greater than the CP may be desirable from a feature success perspective. Accordingly, in order to maintain a MRTD greater than the CP, RTD reporting with an appropriate periodicity may be necessary. More specifically, when a UE measures a RTD less than a parameter X μs (e.g., a specified MRTD), the network may determine to schedule PDSCH signaling for Type 3a/3b UEs. According to some embodiments, the comparison of values such as RTD<X μs should be substantially smaller than a OFDM symbol time. In other words, a measured RTD and/or a specified MRTD (e.g., parameter “X”) should be substantially less than an OFDM symbol timescale.

Additionally, degradation into the first OFDM symbol (e.g., sym0) or last OFDM symbol (e.g., sym13) should be allowed. For example, it may be beneficial to protect OFDM symbols of a preferred or more efficient CC (e.g., a CC with a higher RSRP, RSRQ, etc.) over a less desirable or less efficient CC (e.g., a CC with a lower RSRP, RSRQ, etc.) and allow OFDM symbols of the latter to be degraded/corrupted while maintaining a higher efficiency or fidelity on the protected CC. In some embodiments, the OFDM symbols affected (e.g., degraded/corrupted) may depend on the relative RTD between the two carriers. Accordingly, it may be beneficial to describe a method for enhanced intra-band non-collocated CA such that degraded OFDM symbols may be avoided so as to increase efficiency of CA in non-collocated scenarios.

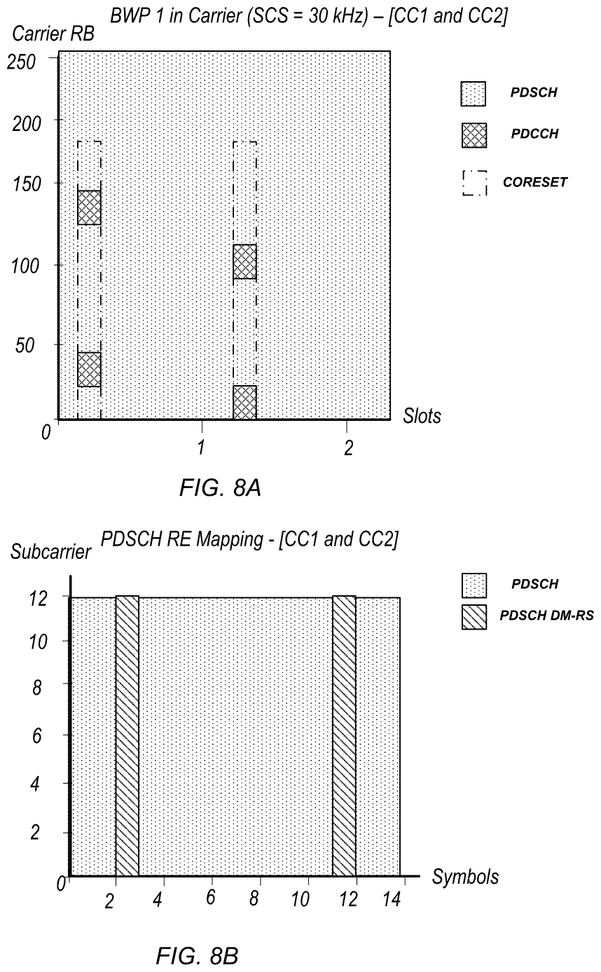

### FIG. 6—Method for Enhanced Intra-Band Non-Collocated Carrier Aggregation

FIG. 6 illustrates a communication flow diagram of an example method for enhanced non-collocated carrier aggregation, according to some embodiments. More specifically, FIG. 6 illustrates how a UE may provide capability information to the network in order to receive adjusted downlink scheduling so as to operate more efficiently in scenarios related to intra-band non-collocated CA. In some embodiments, these enhancements may be used to address the problem in which one or more OFDM symbols in slots of aggregated component carriers may be degraded as a result of phase jumping due to timing issues related to automatic gain control (AGC) of shared low noise amplifiers (LNAs). Aspects of the method of FIG. 6 may be implemented by a wireless device, such as the UE(s) 106, in communication with a network, e.g., via one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. Similarly, aspects of the method of FIG. 6 may be implemented by a network node, such as the BS 102, in communication with a UE 106, as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 302, baseband processor(s), processor(s) associated with communication circuitry, etc., among various possibilities) may cause the UE to perform some or all of the illustrated method elements. Similarly, one or more processors (or processing elements) of the BS (e.g., processor(s) 404, baseband processor(s), processor(s) associated with communication circuitry, etc., among various possibilities) may cause the BS to perform some or all of the illustrated method elements. In some embodiments, the UE may communicate directly with a base station, and the base station may in turn communicate with an access mobility function (AMF) of a 5GC that services the PLMN associated with a terrestrial network (TN). Note that while at least some elements of the method are described in a manner relating to the use of communication techniques and/or features associated with 3GPP specification documents, such description is not intended to be limiting to the disclosure, and aspects of the method may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method may operate as follows.

In 602, the UE may establish a cellular link with a network node (e.g., a BS), according to some embodiments. Additionally or alternatively, the cellular link may operate according to 5G NR. For example, the wireless device may establish a session with an AMF entity of the cellular network by way of one or more gNBs that provide radio access to the cellular network. As another possibility, the cellular link may operate according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

In 604, the UE may transmit capability information to the network node, according to some embodiments. More specifically, the UE may transmit signaling to the network including capability information indicating support of CA of a first CC and a second CC. As previously discussed, for intra-band non-collocated CA, a larger RTD between aggregated component carriers may be observed due to increased separation of antennas as opposed to collocated antennas. Further, a power imbalance between component carriers to be aggregated may be significantly larger than those related to collocated CCs. These two parameters may be important aspects in the scenario of intra-band non-collocated CA. Accordingly, if a UE cannot support the RTD and/or the power balance, the non-collocated CA may not be guaranteed even it is scheduled by the network device. Therefore, when performing CA scheduling, the network device may need to be aware of the capability of the UE with regard to non-collocated CA. Accordingly, it may be beneficial for the UE to indicate to the network whether the UE can support a carrier aggregation with a certain RTD and/or a certain level of power imbalance.

According to some embodiments, the capability information may comprise a UE capability parameter “intraBandNonColocatedCADL-r18” which may indicate that the UE 106 supports a first and/or a second set of parameters for aggregation of non-collocated CCs. The capability information may indicate the capability of supporting a maximum RTD between aggregated component carriers that is not less than a predetermined RTD threshold, according to some embodiments. Additionally or alternatively, the capability information may indicate the capability of supporting a maximum power imbalance between aggregated component carriers that is not less than a predetermined power imbalance threshold. In some embodiments, the capability information may indicate that at least one component carrier supports a maximum of four MIMO layers. In some embodiments, in addition to reporting of the capability of supporting intra-band non-collocated CA, the UE may also report or include in the report to the network an indication of a capability of compatibility with a legacy type of carrier aggregation (e.g., supported by a Type 1 or Type 2 UE.

In 606, the UE may receive downlink signaling on multiple CCs, according to some embodiments. More specifically, the UE may receive, from the network node, physical downlink shared channel (PDSCH) signaling on the first and second CCs. For example, the PDSCH signaling may be received on the first and second component carriers via respective OFDM symbols in slots (e.g., numbered from 0 (sym0) to 13 (sym13)). As briefly mentioned regarding the scenario of intra-band non-collocated carrier aggregation of multiple component carriers, certain OFDM symbols may be degraded in the process of carrier aggregation, according to some embodiments.

According to some instances, the UE may further determine an alignment of a shared low noise amplifier (LNA) with either the first CC or the second CC. More specifically, the UE may determine which of the first CC or second CC is “protected” or “locked”. For example, in order to perform an RTD measurement, the UE may need to determine which carrier (e.g., a first or second carrier) with which to specify a reference point to measure the RTD from. In other words, the UE may need to determine or align with a CC (associated with the reference point) from which to measure the RTD between it (e.g., the determined or selected/aligned CC) and the other CC. As one example, if the UE determines to use a reference point associated with the first CC, it may determine to protect the first OFDM symbol (e.g., sym0) of the first CC while sym0 of the second CC (e.g., unprotected or non-aligned with) may be affected by degradation or corruption. Alternatively, if the UE determines to use a reference point associated with the second CC, then the OFDM sym0 of the second CC may be protected while sym0 of the first CC may be degraded/corrupted, according to some embodiments.

Additionally, the determination of which CC to protect or align with (e.g., selected and associated with a measurement reference point) may be based on one or more reference signal received power (RSRP) metrics, one or more reference signal received quality (RSRQ) metrics, one or more maximum average aggregate throughput metrics associated with the first and/or second CCs. In some embodiments, the determination may be based on which of the first CC or the second CC is associated with a primary cell (PCell). In some embodiments, once the UE has made a determination regarding which carrier the shared LNA will be aligned with (e.g., which carrier will be protected), the UE may transmit an indication of this determination to the network such that the network may schedule and/or adjust subsequent PDSCH signaling according to the indicated determination.

Additionally or alternatively, the determination of which carrier to protect may be based on an indication received by the UE from the network node. For example, according to some embodiments, after receiving RTD reporting from the UE, the network may make the determination regarding which carrier the shared LNA will be aligned with (e.g., which carrier will be protected). In some embodiments, the determination by the network regarding which carrier to protect may be based on formulas, inequalities, or metrics similar to or the same as those used by the UE. Accordingly, the network may schedule and/or adjust subsequent PDSCH signaling according to the indicated determination.

In 608, the UE may measure an RTD between CCs, according to some embodiments. More specifically, the UE may measure an RTD between a start of a first orthogonal frequency division multiplex (OFDM) symbol in a first slot of the first CC and a start of a first OFDM symbol in a first slot of the second CC. Alternatively, the UE may measure an RTD between a start of a first OFDM symbol in a first slot of the first CC and an end of a last OFDM symbol in a previous slot of the second CC. In some embodiments, the UE may measure a negative delay corresponding to a negative RTD (−RTD). For example, if the UE measures an RTD between the start of sym0 of a first CC and the start of a first OFDM symbol in a slot of a second CC (e.g., the start of the sym0 of the second CC), the RTD may be considered to be a negative RTD with respect to a reference point associated with the first CC. Alternatively, the UE may measure a positive RTD (+RTD), according to some embodiments. For example, if the UE measures an RTD between the start of sym0 of a first CC and an end of a last OFDM symbol in a previous slot of a second CC (e.g., the end of the left most sym13 of the second CC), the RTD may be considered to be a positive RTD with respect to a reference point associated with the first CC.

In some embodiments, the UE may determine, based on the measured RTD, a degraded OFDM symbol on either the first CC or the second CC. Additionally or alternatively, the UE may determine that the degraded OFDM symbol will be excluded in subsequent downlink signaling received from the network. Furthermore, the UE may determine that the degraded OFDM symbol is corrupted due a phase jump when an analog gain change does not occur at the beginning of at least one of the first CC or the second CC.

In 610, the UE may transmit an RTD report to the network, according to some embodiments. More specifically, the UE may transmit, to the network node, a report including the measured RTD. The report may include the −RTD or +RTD measured value(s), according to some embodiments. As one alternative, instead of reporting the measured RTD and to save signaling overhead, the UE may only report to the network that whether or not the measured RTD is larger than the predetermined RTD threshold or not, according to some embodiments. In other words, the UE may perform a comparison or calculation related to the measured RTD value and one or more specified parameters (e.g., MRTD, CP, “X” μs, etc.), according to some embodiments.

In 612, the network may compare the measured RTD to signaling metrics, according to some embodiments. More specifically, the network may compare the measured RTD to one or more signaling metrics associated with the first and second CCs. In some embodiments, the comparison of the RTD to one or more signaling metrics may be performed according to the inequality that the measured RTD is less than a cyclic prefix (CP) which is less than X microseconds (μs), where X is a value which may correspond to a maximum receive timing difference (MRTD). Additionally or alternatively, the comparison of the RTD to one or more signaling metrics may be performed according to the inequality that the CP is less than the measured RTD which is less than X μs. In some embodiments, the comparison of the RTD to one or more signaling metrics may be performed according to the inequality that the measured RTD is greater than X μs. In other words, the network may determine that the measured RTD is not less than a predetermined RTD threshold corresponding to enhanced intra-band non-collocated CA. Accordingly, if the condition is satisfied, this may be indicative that said CA is available based on the current network environment, according to some embodiments. According to some embodiments, the network node may further indicate the one or more signaling metrics to the UE such that the UE may perform similar comparisons or calculations related to intra-band non-collocated CA.

In some embodiments, in response to determining that the measured RTD is larger than the predetermined RTD threshold of the type 3 CA while the capability of compatibility with the legacy type of CA is reported, the network node may schedule a legacy type of CA. For example, the network node may activate the non-collocated component carrier of type 2 CA and schedule two MIMO layers on the component carrier. Accordingly, the scheduling may be performed for type 3 CA or fallback to a legacy type of CA (e.g., type 2 CA) based on different network environments. Therefore, the scheduling may be dynamically altered according to the network environment.

As described above, the network node may perform CA scheduling based on the measured RTD from the UE. However, according to other embodiments, the network node may perform CA scheduling based on a maximum RTD instead of the measured RTD from the wireless device. More specifically, in some embodiments, the network node may determine a maximum RTD based on a network deployment related to the network node. For example, the maximum RTD may be determined based on history reports of measured RTDs of a plurality of UEs or wireless devices within the network environment. Alternatively, the maximum RTD may be determined based on other parameters of the network deployment. Accordingly, the network node may schedule the new type of CA in response to determining that the maximum RTD is not less than the predetermined RTD threshold, according to some embodiments.

In 614, the UE may receive, from the network, downlink signaling including adjusted OFDM symbols, according to some embodiments. More specifically, the UE may receive, on first downlink signaling (e.g., downlink control information (DCI), PDSCH, PDCCH, etc.) on the first CC and second downlink signaling on the second CC from the network node. In some embodiments, one of the first DL signaling or second DL signaling may include an adjusted set of OFDM symbols. Additionally or alternatively, the adjusted set of OFDM symbols may be adjusted at least partially based on the measured RTD such that a degraded OFDM symbol associated with one of the CCs (e.g., first or second CC) is avoided. In other words, adjusting the OFDM symbols may correspond to mapping of PDCCH (as one example) to a different set of OFDM symbols and RBs such that degraded OFDM symbols and RBs may be avoided.

For example, in some embodiments, if the measured RTD is less than the CP which is less than a maximum RTD parameter “X” μs, the adjusted downlink signaling may be scheduled such that it uses available symbols in the slot (e.g., ranging from sym0-sym13). Additionally or alternatively, if the CP is less than the measured RTD which is less than “X” μs, the adjusted downlink signaling may be adjusted such that it uses sym1-sym13 range OR sym0-sym12 range (e.g., excluding the first or last symbol in the slot of one of the CCs). In some embodiments, if the measured RTD is greater than “X” μs, the network may determine to refrain from scheduling the adjusted PDSCH signaling. In other words, the adjusted downlink signaling may occupy a reduced number of OFDM symbols on either the first CC or second CC based on the comparison of the measured RTD to the various signaling metric inequalities in order to avoid a degraded OFDM symbol.

More specifically, if degradation into the first OFDM symbol sym0 or last OFDM symbol sym13 is allowed (e.g., as indicated by the UE capability response), then the network may be able to use dynamic downlink scheduling to avoid the degraded OFDM symbol. Accordingly, the network may also need to configure at least one control resource set (CORESET) located between sym1 and sym12 for receiving the physical downlink control channel (PDCCH). Additionally, channel state information-reference signals (CSI-RS) and/or tracking reference signals (TRS) should not occupy possibly degraded OFDM symbols such as sym0 or sym13. However, since synchronization signal blocks (SSBs) and physical broadcast channel resources (PBCH) do not occupy sym0 or sym13, they should not be affected by the aforementioned degradation of sym0 or sym13.

According to some embodiments, the network node may send a measurement object (MO) to the UE which may indicate a non-collocated frequency to be aggregated with the serving frequency of the UE. The non-collocated frequency may correspond to the second component carrier described above (e.g., CC2) and the serving frequency may correspond to the first component carrier described above (e.g., CC1). Furthermore, the network node may indicate the non-collocated frequency to the UE through other means instead of the MO, according to some embodiments.

In some embodiments, the measured RTD may be less than or equal to a maximum receive timing difference (MRTD) and the MRTD may be greater than a cyclic prefix (CP). Accordingly, when the measured RTD is less than or equal to the MRTD, the UE may be capable of supporting an increased power imbalance between the first CC and the second CC. According to further embodiments, the reduced number of OFDM symbols may exclude a degraded OFDM symbol on either the first CC or the second CC and the degraded OFDM symbol may be corrupted due a phase jump when an analog gain change does not occur at the beginning of the slot of either the first CC or the second CC. In some embodiments, the method may be performed by a Type 3a user equipment (UE) or a Type 3b UE. According to further embodiments, a maximum of four multiple input multiple output (MIMO) layers may be supported on the first CC and/or the second CC.

The above-described embodiments may be suitably applied to a new radio (NR) network architecture. In addition, for a dual connectivity network architecture in which a legacy network (e.g., LTE) and an NR is connected, the capability of supporting the new type of carrier aggregation may include: at least one component carrier for the legacy network supporting a maximum of two MIMO layers and at least one component carrier for the NR supporting a maximum of four MIMO layers, according to some embodiments. Additionally or alternatively, scheduling the new type of carrier aggregation may include scheduling two MIMO layers on the at least one component carrier for the legacy network and scheduling four MIMO layers on the at least one component carrier for the NR. In the case of the dual connectivity, the first component carrier may correspond to the component carrier for the legacy network, and the second component carrier may correspond to the component carrier for the NR or vice versa. Further, the dual connectivity may include but not limited to an EN-DC (Evolved Universal Terrestrial Radio Access (E-UTRA)-NR Dual Connectivity).

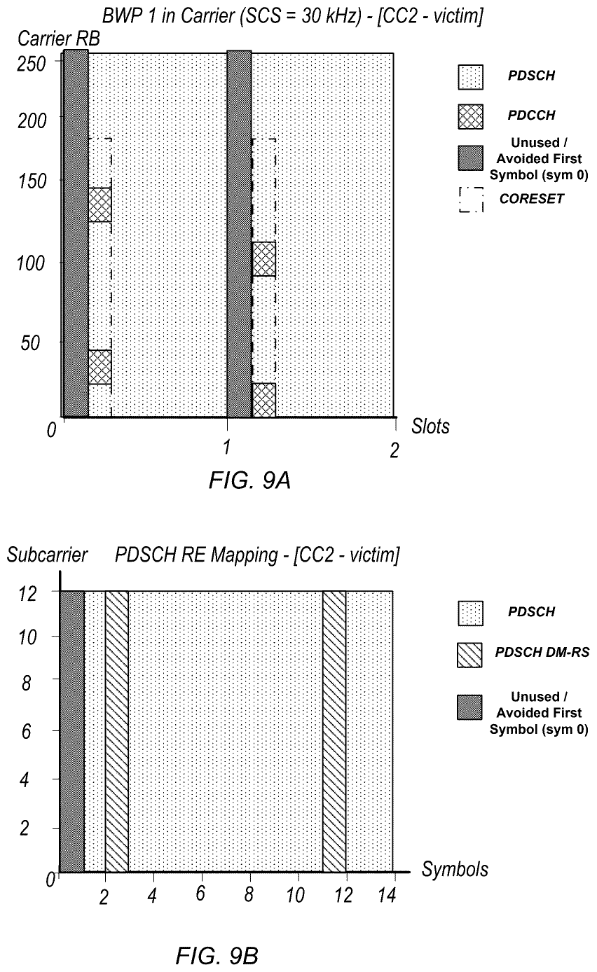

### FIGS. 7A-7B—Relative Time Difference Measurement in Enhanced Intra-Band Non-Collocated Carrier Aggregation

FIGS. 7A and 7B illustrate example aspects of enhanced non-collocated carrier aggregation including relative time different measurements, according to some embodiments. More specifically, FIGS. 7A and 7B illustrates component carriers CC1 and CC2 and respective OFDM symbols in slots (e.g., numbered from 0 (sym0) to 13 (sym13)) of downlink signaling received at the UE from the network. As previously discussed, in the scenario of intra-band non-collocated carrier aggregation of CC1 and CC2, certain OFDM symbols may be degraded in the process of carrier aggregation, according to some embodiments.

FIG. 7A, related to at least part of the method described in FIG. 6, illustrates a negative RTD (−RTD) measurement in relation to reference Point A. In some embodiments, reference point A may correspond to a start of a first orthogonal frequency division multiplex (OFDM) symbol in a first (e.g., current) slot of the first CC (e.g., the start of sym0 of CC1). Accordingly, when the UE measures an RTD between the start of sym0 of CC1 and a start of a first OFDM symbol in a first (e.g., current) slot of the second CC (e.g., the start of sym0 of CC2), the RTD may be considered to be a −RTD with respect to the reference Point A. In other words, FIG. 7A illustrates a first case corresponding to a negative delay (e.g., −RTD) between the component carriers. According to some embodiments, Point A may correspond to a reference point associated with CC1 and therefore CC1 may be considered to be “protected” or “locked”. In other words, because the UE is using reference Point A associated with CC1, it may determine to protect the first OFDM symbol (e.g., sym0) of selected CC1 while sym0 of CC2 may be affected by degradation or corruption, according to some embodiments. Alternatively, if reference Point A was associated with CC2, then the OFDM sym0 of CC2 may be protected while sym0 of CC1 may be degraded/corrupted, according to some embodiments.

FIG. 7B, also related to at least part of the method described in FIG. 6, illustrates a positive RTD (+RTD) measurement in relation to reference Point A. Similar to FIG. 7A, reference point A may correspond to the start of sym0 of CC1 and the UE may measure an RTD between the start of sym0 of CC1 and an end of a last OFDM symbol in a previous slot of the second CC (e.g., the left most sym13 of CC2). Accordingly, when the UE measures an RTD between the start of sym0 of CC1 and an end of a last OFDM symbol in a previous slot of the second CC (e.g., the end of the left most sym13 of CC2), the RTD may be considered to be a positive RTD with respect to the reference Point A. In other words, FIG. 9B illustrates a second case corresponding to a positive delay (e.g., +RTD) between the component carriers. According to some embodiments, Point A may correspond to a reference point associated with CC1 and therefore CC1 may be considered to be “protected” or “locked”. In other words, because the UE is using reference Point A associated with CC1, it may determine to protect the first OFDM symbol (e.g., sym0) of selected CC1 while the left most sym13 (e.g., from a previous slot) of CC2 may be affected by degradation or corruption, according to some embodiments. Alternatively, if reference Point A was associated with CC2, then the left most OFDM sym13 of CC2 may be protected while sym0 of CC1 may be degraded/corrupted, according to some embodiments.

As discussed above, the UE's measurement of the RTD may depend on reference Point A which may correspond to the carrier which is ‘locked” or “protected”. This determination or selection of which component carrier is protected may be based on a policy. For example, a policy may be utilized to select which carrier will be used to indicate reference Point A, according to some embodiments. In other words, a carrier alignment policy may be used to indicate which carrier gets protected and is used as reference for “Point A”. Consequently, the other carrier (e.g., not protected) may be indicated as the carrier which is affected by OFDM symbol degradation/corruption. As briefly mentioned, the degradation or corruption may be due to a phase jump when the analog gain change of a shared low noise amplifier (LNA) of collocated antennas does not start exactly at the beginning of the slot.

According to some embodiments, the UE may decide or determine to which carrier the shared LNA will aligned to (e.g., which carrier is protected). For example, the UE may make this determination or selection based on RSRP, RSRQ or other signal-based metrics, a maximum average aggregate throughput, or the UE may always align to the carrier associated with a primary cell (PCell) rather than a secondary cell. Alternatively, in some embodiments, the network may indicate to the UE to which carrier the shared LNA should be aligned to.

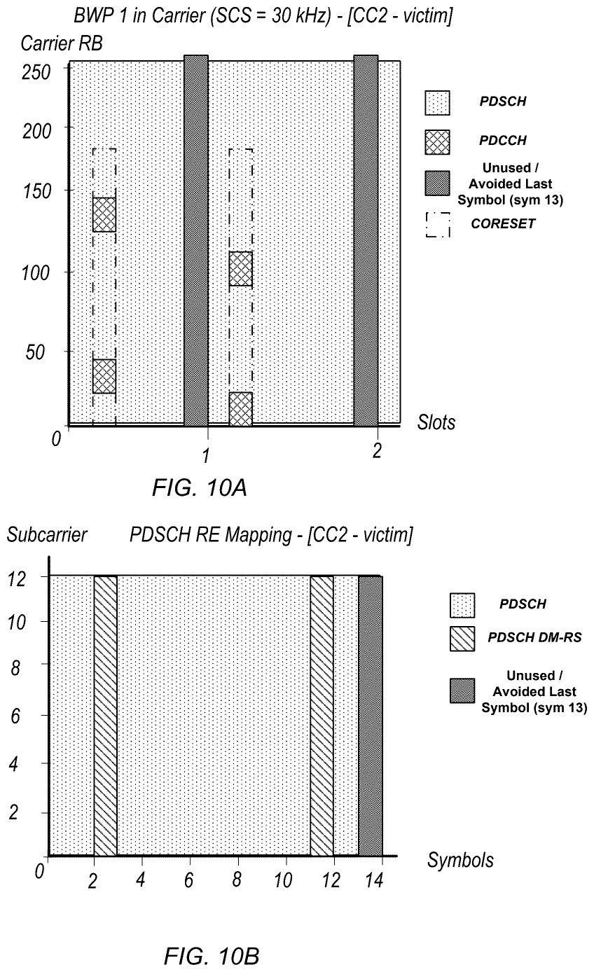

### FIGS. 8-10—Dynamic PDSCH Scheduling Techniques

FIGS. 8-10 illustrate example aspects of enhanced non-collocated carrier aggregation related to dynamic PDSCH scheduling, according to some embodiments. More specifically, FIGS. 8-10 illustrate potential mappings of PDCCH and CORESET (for reception of a PDCCH, as one example), across carrier resource blocks (RBs) versus their respective slots, according to some embodiments. Additionally, FIGS. 8-10 illustrate mappings of PDSCH demodulation reference signals (DM-RS) across subcarriers versus their respective symbols (sym), according to some embodiments.

For example, FIGS. 8A-B illustrate a first case or scenario for dynamic PDSCH scheduling if degradation into the first OFDM symbol (e.g., sym0) or degradation of the last OFDM symbol (sym13) is allowed and the measured RTD is less than the CP which is less than a maximum RTD parameter “X” μs, according to some embodiments. FIG. 8A illustrates an example configuration of PDCCH and CORESET across carrier RBs versus their respective slots. More specifically, FIG. 8A illustrates, for both a first component carrier and a second component carrier (e.g., CC1 and CC2) and corresponding to a first BWP (e.g., BWP 1) and subcarrier spacing (SCS) of 30 kHz, an example of how multiple PDCCHs and CORESETs for multiple slots may be configured for carrier RBs. For example, FIG. 8A illustrates two PDCCHs associated with a first slot (e.g., between slots 0 and 1) configured for a portion of the RBs between 0 and 50 and a portion of the RBs between 100 and 150, according to some embodiments. Additionally, FIG. 8A illustrates two PDCCHs associated with a second slot (e.g., between slots 1 and 2) configured for a portion of the RBs near RB 100 and a portion of the RBs at or around RB 0, according to some embodiments. Additionally, FIG. 8A illustrates that CORESETs for the first and second slots may be configured for RBs at least from 0 to approximately RB 200. Accordingly and in other words, at least one CORESET may be configured between sym1 and sym12 for PDCCH, according to some embodiments. Additionally, FIG. 8A illustrates an example of how the physical downlink shared channel (PDSCH) may be configured with respect to the carrier RBs versus the slots, according to some embodiments.

FIG. 8B, also corresponding to the first case or scenario of FIG. 8A, illustrates the mappings of PDSCH DM-RS across subcarriers versus their respective symbols, according to some embodiments. More specifically, FIG. 8B illustrates for both a first component carrier and a second component carrier (e.g., CC1 and CC2), an example of how multiple PDSCHs DM-RS and their respective symbols may be configured across subcarriers. For example, FIG. 8B illustrates a first PDSCH DM-RS associated with a third symbol of a slot (e.g., sym2, spanning from sym 2 to sym3) configured across subcarriers 0 to 12, according to some embodiments. Additionally, FIG. 8B illustrates a second PDSCH DM-RS associated with a eleventh symbol of the slot (e.g., sym12, spanning from the eleventh symbol to the twelfth symbol) configured across subcarriers 0 to 12, according to some embodiments. Accordingly, in this first case, the adjusted downlink signaling may be scheduled such that it may use available symbols in the slot (e.g., ranging from sym0-sym13). Accordingly, and as briefly discussed above, FIGS. 8A and 8B would be applicable (e.g., accurately describe) for both CC1 and CC2 in the scenario in which degradation into the first OFDM symbol (e.g., sym0) or degradation of the last OFDM symbol (sym13) is allowed and the measured RTD is less than the CP which is less than a maximum RTD parameter “X” μs, according to some embodiments. Additionally, FIG. 8B illustrates an example of how the PDSCH may be configured with respect to the subcarriers versus the symbols, according to some embodiments.

FIGS. 9A-B illustrate a second case or scenario for dynamic PDSCH scheduling if degradation into the first OFDM symbol (e.g., sym0) or degradation of the last OFDM symbol (sym13) is allowed and the CP is less than the measured RTD which is less than a maximum RTD parameter “X” μs, according to some embodiments. More specifically, FIG. 9A illustrates adjusted downlink signaling of a victim CC (as opposed to a protected CC such as CC1) which is adjusted such that it uses sym1-sym13 range (e.g., excluding the first symbol in the slot of the victim CC). In other words, the adjusted downlink signaling of the victim CC (e.g., CC2) may occupy or be configured with a reduced number of OFDM symbols (as compared to protected CC1 which may be characterized by FIGS. 8A and 8B) based on the comparison of the measured RTD to the various signaling metric inequalities in order to avoid a degraded OFDM symbol.

Accordingly and related to this second case or scenario in which the CP is less than the measured RTD which is less than a maximum RTD parameter “X” μs, FIG. 9A illustrates an example configuration of PDCCH and CORESET across carrier RBs versus their respective slots. More specifically, FIG. 9A illustrates, for a victim component carrier (e.g., CC2) and corresponding to a first BWP (e.g., BWP 1) and subcarrier spacing (SCS) of 30 kHz, an example of how multiple PDCCHs and CORESETs for multiple slots may be configured for carrier RBs. For example, FIG. 9A illustrates two PDCCHs associated with a first slot (e.g., between slots 0 and 1) configured for a portion of the RBs between 0 and 50 and a portion of the RBs between 100 and 150, according to some embodiments. Additionally, FIG. 9A illustrates two PDCCHs associated with a second slot (e.g., between slots 1 and 2) configured for a portion of the RBs near RB 100 and a portion of the RBs at or around RB 0, according to some embodiments. Moreover, FIG. 9A illustrates that CORESETs for the first and second slots may be configured for RBs at least from 0 to approximately RB 200. Importantly, since the adjusted downlink signaling of this victim CC is adjusted such that it uses sym1-sym13 range (e.g., excluding the first symbol in the slot of the victim CC), FIG. 9A illustrates that the carrier RBs from 0 to approximately 250 associated with a first symbol of the slots may correspond to unused or avoided RBs associated with the degraded first symbol (e.g., sym0) in the first slot and second slots of the victim CC, according to some embodiments. Additionally, FIG. 9A illustrates an example of how the PDSCH may be configured with respect to the carrier RBs versus the slots, according to some embodiments.

FIG. 9B illustrates a first PDSCH DM-RS associated with a third symbol of a slot (e.g., sym2, spanning from sym2 to sym3) configured across subcarriers 0 to 12, according to some embodiments. Additionally, FIG. 9B illustrates a second PDSCH DM-RS associated with a eleventh symbol of the slot (e.g., sym 12, spanning sym11 to sym 12) configured across subcarriers 0 to 12, according to some embodiments. Accordingly, in this second scenario or case in which the CP is less than the measured RTD which is less than a maximum RTD parameter “X” μs, FIG. 9B illustrates unused or avoided first symbols across subcarriers 0 to 12 which correspond to the first symbol (e.g., sym0) associated with a degraded OFDM symbol of the victim CC (e.g., CC2), according to some embodiments. Additionally, while FIGS. 9A and 9B describe configurations of a victim carrier CC2, as briefly discussed above, FIGS. 8A and 8B would be applicable (e.g., accurately describe) for the protected carrier (e.g., CC1) in this second scenario, according to some embodiments. Moreover, FIG. 9B illustrates an example of how the PDSCH may be configured with respect to the subcarriers versus the symbols, according to some embodiments. In other words, FIGS. 9A-B illustrate a technique for dynamic PDSCH scheduling in which a first symbol in the slot (e.g., sym0) is avoided or unused which results in a reduced or lesser number of symbols (e.g., 13 rather than 14) for the scheduled PDSCH.

FIGS. 10A-B illustrate secondary aspects related to the second case or scenario described in FIGS. 9A-B. For example, FIGS. 10A-B illustrate a secondary scenario if dynamic PDSCH scheduling if degradation into the first OFDM symbol (e.g., sym0) or degradation of the last OFDM symbol (sym13) is allowed and the CP is less than the measured RTD which is less than a maximum RTD parameter “X” μs, according to some embodiments. More specifically, FIG. 10A illustrates adjusted downlink signaling of a victim CC (as opposed to a protected CC such as CC1) which is adjusted such that it uses sym0-sym12 range (e.g., excluding the last symbol in the slot of the victim CC). In other words, the adjusted downlink signaling of the victim CC (e.g., CC2) may occupy or be configured with a reduced number of OFDM symbols (as compared to protected CC1 which may be characterized by FIGS. 8A and 8B) based on the comparison of the measured RTD to the various signaling metric inequalities in order to avoid a degraded OFDM symbol.

Accordingly and related to this second case or scenario in which the CP is less than the measured RTD which is less than a maximum RTD parameter “X” μs, FIG. 10A illustrates an example configuration of PDCCH and CORESET across carrier RBs versus their respective slots. More specifically, FIG. 10A illustrates, for a victim component carrier (e.g., CC2) and corresponding to a first BWP (e.g., BWP 1) and subcarrier spacing (SCS) of 30 kHz, an example of how multiple PDCCHs and CORESETs for multiple slots may be configured for carrier RBs. For example, FIG. 10A illustrates two PDCCHs associated with a first slot (e.g., between slots 0 and 1) configured for a portion of the RBs between 0 and 50 and a portion of the RBs between 100 and 150, according to some embodiments. Additionally, FIG. 10A illustrates two PDCCHs associated with a second slot (e.g., between slots 1 and 2) configured for a portion of the RBs near RB 100 and a portion of the RBs at or around RB 0, according to some embodiments. Moreover, FIG. 10A illustrates that CORESETs for the first and second slots may be configured for RBs at least from 0 to approximately RB 200. Importantly, since the adjusted downlink signaling of this victim CC is adjusted such that it uses sym0-sym12 range (e.g., excluding the last symbol in the slot of the victim CC), FIG. 10A also illustrates that the carrier RBs from 0 to approximately 250 may correspond to RBs which are unused or avoided due to their association with the degraded OFDM last symbol in the first slot and second slots of the victim CC (e.g., sym13), according to some embodiments. Additionally, FIG. 10A illustrates an example of how the PDSCH may be configured with respect to the carrier RBs versus the slots, according to some embodiments.

FIG. 10B illustrates a first PDSCH DM-RS associated with a third symbol of a slot (e.g., sym2, spanning from sym2 to sym3) configured across subcarriers 0 to 12, according to some embodiments. Additionally, FIG. 10B illustrates a second PDSCH DM-RS associated with an eleventh symbol of the slot (e.g., sym 12, spanning sym11 to sym 12) configured across subcarriers 0 to 12, according to some embodiments. Accordingly, in this secondary scenario related to the case in which the CP is less than the measured RTD which is less than a maximum RTD parameter “X” μs, FIG. 10B illustrates unused or avoided symbols (e.g., last symbols) across subcarriers 0 to 12 correspond to the last symbol (e.g., sym13, spanning from the thirteenth symbol to the fourteenth symbol) associated with the victim CC (e.g., CC2), according to some embodiments. Additionally, and as briefly discussed above, FIGS. 8A and 8B would be applicable (e.g., accurately describe) for the protected carrier (e.g., CC1) in this second scenario, according to some embodiments. Moreover, FIG. 10B illustrates an example of how the PDSCH may be configured with respect to the subcarriers versus the symbols, according to some embodiments. In other words, FIGS. 10A-B illustrate a technique for dynamic PDSCH scheduling in which a last symbol in the slot (e.g., sym13) is avoided or unused which results in a reduced or lesser number of symbols (e.g., 13 rather than 14) for the scheduled PDSCH.

### Additional Information

According to some embodiments related to intra-band non-collocated CA, UE capability parameter “intraBandNonColocatedCADL-r18” may indicate that the UE supports frequency division duplex (FDD)-FDD or time division duplex (TDD)-TDD intra/inter-band non-collocated CA operation with additional requirements (discussed in TS 38.101 along with demodulation requirements) and may support a MRTD <33 μs according to TS 38.133. (e.g., a Type 2 UE).

According to some embodiments, if the capability is not reported, the UE may support FDD-FDD or TDD-TDD intra/inter-band operation with NR CA MRTD<3 μs (e.g., a Type 1 UE). In some embodiments, the UE capability parameter “intraBandNonColocatedCADL-r18” may indicate the level at which the associated parameter is included and the parameter may be signaled per band combination.

In some embodiments, if there is an absence of the UE capability parameter “intraBandNonColocatedCADL-r18” from the capability information, this may indicate that the UE 106 supports a first set of parameters for aggregation of non-collocated CCs. For example, the set of parameters for aggregation of non-collocated CCs may comprise a first set of parameters for aggregation of the non-collocated CCs. The first set may include a first threshold for power imbalance between the non-collocated CCs and a second threshold for maximum received time difference (MRTD) between the non-collocated CCs. In some embodiments, the first threshold for power imbalance may be equal to 6 dB and the second threshold for the MRTD may be equal to 3 μs.

Alternatively, in some embodiments, the set of parameters for aggregation of non-collocated CCs may comprise a second set of parameters for aggregation of the non-collocated CCs. The second set comprises a third threshold for the power imbalance and a fourth threshold for the MRTD. The third threshold may be higher than the first threshold, and the fourth threshold may be higher than the second threshold. In some embodiments, the third threshold for power imbalance may be equal to 25 dB and the fourth threshold for the MRTD may be equal to 33 μs.

In some embodiments, the first set of parameters for aggregation of non-collocated CCs may be associated with an existing minimum radio frequency (RF) requirement in TS 38.101 and an existing demodulation performance in TS 38.101. In some embodiments, the second set of parameters for aggregation of non-collocated CCs may be associated with a new minimum RF requirement to be introduced in TS 38.101 so as to test reference sensitivity requirements in presence of a jammer of 25 dB higher than the wanted signal. Some reference sensitivity degradation should be allowed. In such embodiments, the UE 106 may use separate RF chain to receive the aggregated carriers.

In some embodiments, additionally or alternatively, the second set of parameters for aggregation of non-collocated CCs may be associated with a new demodulation performance to be introduced in TS 38.101 so as to verify power imbalance of 25 dB between wanted signal and the aggregated carrier on adjacent channel. In some embodiments, a UE supporting the first set of parameters for aggregation of non-collocated CCs may be referred to as a Type 1 UE. In some embodiments, a UE supporting the second set of parameters for aggregation of non-collocated CCs may be referred to as a Type 2 UE.

In some embodiments, it may be beneficial to increase the opportunities for Type 1 UE to be scheduled by the base station 102 with the assistance of additional information report, such as reference signal received power (RSRP). The RSRP may be reported separately for the serving cell and target cell. Accordingly, the base station 102 may be able to use this information for scheduling and activation or deactivation of a CC associated with a secondary cell (Scell). However, more frequency reports may be needed and hence there may be a larger signaling overhead burden.

In order to reduce the signaling overhead, the measurements may include a first reference signal received power (RSRP) of a strongest cell among the serving cell and the at least one candidate secondary cell and an indication of an RSRP difference between the first RSRP and a second RSRP. The second RSRP may be for a cell among the serving cell and the at least one candidate secondary cell. The cell may be different from the strongest cell. In other words, the UE 106 may report the RSRP of the strongest cell and the RSRP difference between the RSRP of the strongest cell and an RSRP of other cell. In some embodiments, a granularity for the RSRP difference and a range of the RSRP difference may be predefined. In some embodiments, the granularity for the RSRP difference may be 1 dB and the range of the RSRP difference may be 0 dB-30 dB. For example, Table 1 below shows examples of the RSRP difference reporting. In Table 1, the RSRP difference is also referred to as differential RSRP.

TABLE 1

| Reported | Measured quantity | |
|---|---|---|
| value | value | Unit |
| DIFFRSRP_0 | −30 ≥ ΔRSRP | dB |
| DIFFRSRP_1 | −29 ≥ ΔRSRP > −30 | dB |
| DIFFRSRP_2 | −28 ≥ ΔRSRP > −29 | dB |
| DIFFRSRP_3 | −27 ≥ ΔRSRP > −28 | dB |
| DIFFRSRP_4 | −26 ≥ ΔRSRP > −27 | dB |
| DIFFRSRP_5 | −25 ≥ ΔRSRP > −26 | dB |
| DIFFRSRP_6 | −24 ≥ ΔRSRP > −25 | dB |
| . . . | . . . | . . . |
| DIFFRSRP_25 | −5 ≥ ΔRSRP > −6 | dB |
| DIFFRSRP_26 | −4 ≥ ΔRSRP > −5 | dB |
| DIFFRSRP_27 | −3 ≥ ΔRSRP > −4 | dB |
| DIFFRSRP_28 | −2 ≥ ΔRSRP > −3 | dB |
| DIFFRSRP_29 | −1 ≥ ΔRSRP > −2 | dB |
| DIFFRSRP_30 | 0 ≥ ΔRSRP > −1 | dB |

In some embodiments, the measurements further comprise a system frame number (SFN) and Frame Timing Difference (SFTD) between the serving cell and one of the at least one candidate secondary cell.

In some embodiments, if the capability information indicating that the UE 106 supports the first set of parameters, the RSRP difference may be below a fifth threshold for the power imbalance and the SFTD may be below a sixth threshold for the MRTD. Accordingly, the BS 102 may transmit a first signaling for activating the non-collocated CCs to the UE 106.

In some embodiments, the fifth threshold may be equal to or greater than the first threshold for the power imbalance and less than the third threshold for the power imbalance. For example, the fifth threshold may be equal to 6 dB or slightly larger than 6 dB.

In some embodiments, the sixth threshold may be equal to or greater than the second threshold for the MRTD and less than the fourth threshold for the MRTD. For example, the sixth threshold may be equal to 3 μs or slightly larger than 3 μs.

In some embodiments, if the capability information indicating whether the UE 106 supports the second set of parameters, and the RSRP difference is above the first threshold for power imbalance and below the third threshold for the power imbalance, or the SFTD is above the second threshold for MRTD and below the fourth threshold for the MRTD, the BS 102 may transmit a first signaling for activating the non-collocated CCs to the UE 106.

In some embodiments, in order to further reduce the signaling overhead, the measurements may not comprise the RSRP difference and the SFTD. Instead, the measurements may comprise a first flag. The first flag may indicate that the RSRP difference is below the fifth threshold for the power imbalance and the SFTD is below the sixth threshold for the MRTD. The fifth threshold may be equal to or greater than the first threshold. The sixth threshold for the MRTD may be equal to or greater than the second threshold for the MRTD. Alternatively, the measurements may comprise a second flag. The second flag may indicate that the RSRP difference is above the fifth threshold for the power imbalance or the SFTD is above the sixth threshold for the MRTD.

In some embodiments, the set of parameters for aggregation of non-collocated CCs may include a first set of parameters for aggregation of the non-collocated CCs, the first set including a first threshold for power imbalance between the non-collocated CCs and a second threshold for maximum receiving time difference (MRTD) between the non-collocated CCs, or a second set of parameters for aggregation of the non-collocated CCs, the second set including a third threshold for the power imbalance and a fourth threshold for the MRTD, the third threshold being higher than the first threshold, and the fourth threshold being higher than the second threshold.

In some embodiments, transmitting the signaling for activating or deactivating the non-collocated CCs may include, in accordance with a determination that the capability information indicating whether the UE supports the second set of parameters, and the RSRP difference is above the first threshold for power imbalance and below the third threshold for the power imbalance, or the SFTD is above the second threshold for MRTD and below the fourth threshold for the MRTD, transmitting a first signaling for activating the non-collocated CCs.

In some embodiments, the measurements may include a first flag indicating that the RSRP difference is below a fifth threshold for the power imbalance and the SFTD is below a sixth threshold for the MRTD, the fifth threshold being equal to or greater than the first threshold for the power imbalance and less than the third threshold for the power imbalance, the sixth threshold being equal to or greater than the second threshold for the MRTD and less than the fourth threshold for the MRTD, or a second flag indicating that the RSRP difference is above the fifth threshold for the power imbalance or the SFTD is above the sixth threshold for the MRTD.

In some embodiments, transmitting the signaling for activating or deactivating the non-collocated CCs may include, in accordance with a determination that the measurements include the first flag, transmitting a first signaling for activating the non-collocated CCs; and in accordance with a determination that the measurements comprises the second flag, transmitting a second signaling for deactivating the non-collocated CCs.

### Example Embodiments

In some embodiments, a method may include establishing a cellular link with a network node and transmitting, to the network node, signaling including capability information indicating support of carrier aggregation (CA) of a first component carrier (CC) and a second CC. The method may further include receiving, from the network node, physical downlink shared channel (PDSCH) signaling on the first and second CCs and measuring a relative time difference (RTD) between a start of a first orthogonal frequency division multiplex (OFDM) symbol in a current slot of the first CC and a start of a first OFDM symbol in a current slot of the second CC. Alternatively, the method may include measuring an RTD between a start of a first OFDM symbol in a current slot of the first CC and an end of a last OFDM symbol in a previous slot of the second CC. The method may also include transmitting, to the network node, a report including the measured RTD and receiving, from the network node, first downlink (DL) signaling on the first CC and second DL signaling on the second CC. According to some embodiments, one of the first DL signaling or second DL signaling may include an adjusted set of OFDM symbols. Additionally or alternatively, the adjusted set of OFDM symbols may be adjusted at least partially based on the measured RTD such that a degraded OFDM symbol is avoided.

According to some instances, the method may further include determining a measurement reference point of the first CC or the second CC. Additionally, the measurement reference point may correspond to a CC which is the other of the one of the first CC or second CC associated with the adjusted set of OFDM symbols, according to some embodiments. In some embodiments, the determination may be based on one or more reference signal received power (RSRP) metrics, one or more reference signal received quality (RSRQ) metrics, one or more maximum average aggregate throughput metrics associated with the first and second CCs. In some embodiments, the determination may be based on which of the first CC or the second CC is associated with a primary cell (PCell). Additionally or alternatively, the determination may be at least partially based on an indication received from the network node.

In some embodiments, the measured RTD may be less than or equal to a maximum receive timing difference (MRTD) and the MRTD may be greater than a cyclic prefix (CP). Accordingly, when the measured RTD is less than or equal to the MRTD, the UE may be capable of supporting an increased power imbalance between the first CC and the second CC. According to further embodiments, the method may include determining, based on the measured RTD, a degraded OFDM symbol associated with either the first CC or the second CC. In some embodiments, the degraded OFDM symbol may be corrupted due a phase jump when an analog gain change does not occur at the beginning of at least one of the first CC or the second CC. In some embodiments, the method may be performed by a Type 3a user equipment (UE) or a Type 3b UE.

In some embodiments, a method may include establishing a radio resource control (RRC) connection with a user equipment (UE) and receiving, from the UE, signaling including capability information indicating support of carrier aggregation (CA) of a first component carrier (CC) and a second CC. The method may further include transmitting, to the UE, physical downlink shared channel (PDSCH) signaling on the first and second CCs and receiving, from the UE, a report comprising a measured relative time difference (RTD). In some embodiments, the measured RTD may be an RTD between a start of a first orthogonal frequency division multiplex (OFDM) symbol in a current slot of the first CC and a start of a first OFDM symbol in a current slot of the second CC or an RTD between a start of a first OFDM symbol in a current slot of the first CC and an end of a last OFDM symbol in a previous slot of the second CC. The method may further include comparing the measured RTD to one or more signaling metrics associated with the first and second CCs and transmitting, to the UE, transmitting, to the UE, first downlink (DL) signaling on the first CC and second DL signaling on the second CC. According to some embodiments, one of the first DL signaling or second DL signaling may include an adjusted set of OFDM symbols. Additionally or alternatively, the adjusted set of OFDM symbols may be adjusted to avoid a degraded OFDM symbol and may be at least partially based on the comparison of the measured RTD to the one or more signaling metrics.

According to further embodiments, the method may include transmitting, to the UE, signaling including an indication of an alignment of a shared low noise amplifier (LNA) with either the first CC or the second CC. Additionally or alternatively, the method may include configuring, for reception of a physical downlink control channel (PDCCH), at least one control resource set (CORESET) located after the first OFDM symbol. In some embodiments, the comparison of the RTD to one or more signaling metrics may be performed according to the inequality that the measured RTD is less than a cyclic prefix (CP) which is less than X microseconds (μs), where X is value which may correspond to a maximum receive timing difference (MRTD). Additionally or alternatively, the comparison of the RTD to one or more signaling metrics may be performed according to the inequality that the CP is less than the measured RTD which is less than X μs. In some embodiments, the comparison of the RTD to one or more signaling metrics may be performed according to the inequality that the measured RTD is greater than X μs.

In some embodiments, if the measured RTD is less than the CP which is less than X μs, the method may further include scheduling the adjusted PDSCH signaling using available symbols in a slot (e.g., in the range from sym0-sym13). Additionally or alternatively, if the CP is less than the measured RTD which is less than X μs, the method may further include scheduling the adjusted PDSCH signaling using symbols in the range from sym1-sym13 range or symbols in the range from sym0-sym12 (e.g., excluding the first or last symbol in the slot of one of the CCs). In some embodiments, if the measured RTD greater than X μs, the method may further include refraining from scheduling the adjusted PDSCH signaling. According to further embodiments, a maximum of four multiple input multiple output (MIMO) layers may be supported on the first CC and/or the second CC.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
establishing a cellular link with a network node;
transmitting, to the network node, signaling including capability information indicating support of carrier aggregation (CA) of a first component carrier (CC) and a second CC;
receiving, from the network node, physical downlink shared channel (PDSCH) signaling on the first and second CCs;
measuring a relative time difference (RTD) between at least one of the following associated with the PDSCH signaling:
a start of a first orthogonal frequency division multiplex (OFDM) symbol in a current slot of the first CC and a start of a first OFDM symbol in a current slot of the second CC, or
a start of a first OFDM symbol in a current slot of the first CC and an end of a last OFDM symbol in a previous slot of the second CC;
transmitting, to the network node, a report comprising the measured RTD; and
receiving, from the network node, first downlink (DL) signaling on the first CC and second DL signaling on the second CC, wherein one of the first DL signaling or second DL signaling comprises an adjusted set of OFDM symbols, and wherein the adjusted set of OFDM symbols is adjusted at least partially based on the measured RTD such that a degraded OFDM symbol is avoided.

2. The method of claim 1, further comprising:
determining a measurement reference point of the first CC or the second CC, wherein the measurement reference point corresponds to a CC which is the other of the one of the first CC or second CC associated with the adjusted set of OFDM symbols.

3. The method of claim 2, wherein the determination is at least partially based on at least one of the following:
one or more reference signal received power (RSRP) metrics associated with the first and second CCs;
one or more reference signal received quality (RSRQ) metrics associated with the first and second CCs;
one or more maximum average aggregate throughput metrics associated with the first and second CCs; or
which of the first CC or the second CC is associated with a primary cell (PCell).

4. The method of claim 2, wherein the determination is at least partially based on an indication received from the network node.

5. The method of claim 1, wherein when the measured RTD is less than or equal to a maximum receive timing difference (MRTD), a user equipment (UE) is capable of supporting an increased power imbalance between the first CC and the second CC.

6. The method of claim 5, wherein the MRTD is greater than a cyclic prefix (CP).

7. The method of claim 1, further comprising:
determining, based on the measured RTD, whether the degraded OFDM symbol is associated with either the first CC or the second CC.

8. The method of claim 7, further comprising:
determining that the degraded OFDM symbol is corrupted due a phase jump when an analog gain change does not occur at the beginning of at least one of the first CC or the second CC.

9. The method of claim 1, wherein the method is performed by a Type 3a user equipment (UE) or a Type 3b UE.

10. A method, comprising:
establishing a radio resource control (RRC) connection with a user equipment (UE);
receiving, from the UE, signaling including capability information indicating support of carrier aggregation (CA) of a first component carrier (CC) and a second CC;
transmitting, to the UE, physical downlink shared channel (PDSCH) signaling on the first and second CCs;
receiving, from the UE, a report comprising a measured relative time difference (RTD) between at least one of the following associated with the PDSCH signaling:
a start of a first orthogonal frequency division multiplex (OFDM) symbol in a current slot of the first CC and a start of a first OFDM symbol in a current slot of the second CC, or
a start of a first OFDM symbol in a current slot of the first CC and an end of a last OFDM symbol in a previous slot of the second CC;
comparing the measured RTD to one or more signaling metrics associated with the first and second CCs;
transmitting, to the UE, first downlink (DL) signaling on the first CC and second DL signaling on the second CC, wherein one of the first DL signaling or second DL signaling comprises an adjusted set of OFDM symbols, and wherein the adjusted set of OFDM symbols is adjusted to avoid a degraded OFDM symbol and is at least partially based on the comparison of the measured RTD to the one or more signaling metrics.

11. The method of claim 10, further comprising:
transmitting, to the UE, signaling comprising an indication of an alignment of a shared low noise amplifier (LNA) with either the first CC or the second CC.

12. The method of claim 10, further comprising:
configuring, for reception of a physical downlink control channel (PDCCH), at least one control resource set (CORESET) located after a first OFDM symbol in at least one of the first CC or the second CC.

13. The method of claim 10, wherein the comparison of the RTD to one or more signaling metrics comprises determining which one of the following inequalities is satisfied:
the measured RTD is less than a cyclic prefix (CP) which is less than X microseconds (μs), wherein X is value corresponding to a maximum receive timing difference (MRTD);
the CP is less than the measured RTD which is less than X μs; or
the measured RTD is greater than X μs.

14. The method of claim 13, wherein:
if the measured RTD is less than the CP which is less than X μs, the method further comprises scheduling the adjusted PDSCH signaling within available symbols in a slot corresponding to a range between sym0 and sym13;
if the CP is less than the measured RTD which is less than X μs, the method further comprises scheduling the adjusted PDSCH signaling within available symbols in a slot except a first symbol or a last symbol corresponding respectively to one of a range between sym1-sym13 or sym0-sym12; or
if the measured RTD is greater than X μs, the method further comprises refraining from scheduling the adjusted PDSCH signaling.

15. The method of claim 10, wherein a maximum of four multiple input multiple output (MIMO) layers are supported on at least one of the first CC or the second CC.

16. The method of claim 10, wherein the UE is a Type 3a UE or a Type 3b UE.

17. An apparatus, comprising:
at least one processor configured to cause a user equipment (UE) to:
establish a cellular link with a network node;
transmit, to the network node, signaling including capability information indicating support of carrier aggregation (CA) of a first component carrier (CC) and a second CC;
receive, from the network node, physical downlink shared channel (PDSCH) signaling on the first and second CCs;
measure a relative time difference (RTD) between at least one of the following associated with the PDSCH signaling:
a start of a first orthogonal frequency division multiplex (OFDM) symbol in a current slot of the first CC and a start of a first OFDM symbol in a current slot of the second CC, or
a start of a first OFDM symbol in a current slot of the first CC and an end of a last OFDM symbol in a previous slot of the second CC;
transmit, to the network node, a report comprising the measured RTD; and
receive, from the network node, first downlink (DL) signaling on the first CC and second DL signaling on the second CC, wherein one of the first DL signaling or second DL signaling comprises an adjusted set of OFDM symbols, and wherein the adjusted set of OFDM symbols is adjusted at least partially based on the measured RTD such that a degraded OFDM symbol is avoided.

18. The apparatus of claim 17, wherein the at least one processor is further configured to cause the UE to:
determine a measurement reference point of the first CC or the second CC, wherein the measurement reference point corresponds to a CC which is the other of the one of the first CC or second CC associated with the adjusted set of OFDM symbols.

19. The apparatus of claim 18, wherein the determination is at least partially based on at least one of the following:
one or more reference signal received power (RSRP) metrics associated with the first and second CCs;
one or more reference signal received quality (RSRQ) metrics associated with the first and second CCs;
one or more maximum average aggregate throughput metrics associated with the first and second CCs; or
which of the first CC or the second CC is associated with a primary cell (PCell).

20. The apparatus of claim 18, wherein the determination is at least partially based on an indication received from the network node.

21. The apparatus of claim 17, wherein when the measured RTD is less than or equal to a maximum receive timing difference (MRTD), a user equipment (UE) is capable of supporting an increased power imbalance between the first CC and the second CC.

22. The apparatus of claim 17, further comprising:
a radio operably coupled to the at least one processor.

23. An apparatus, comprising:
at least one processor configured to cause a network node to:
establish a radio resource control (RRC) connection with a user equipment (UE);
receive, from the UE, signaling including capability information indicating support of carrier aggregation (CA) of a first component carrier (CC) and a second CC;
transmit, to the UE, physical downlink shared channel (PDSCH) signaling on the first and second CCs;
receive, from the UE, a report comprising a measured relative time difference (RTD) between at least one of the following associated with the PDSCH signaling:
a start of a first orthogonal frequency division multiplex (OFDM) symbol in a current slot of the first CC and a start of a first OFDM symbol in a current slot of the second CC, or
a start of a first OFDM symbol in a current slot of the first CC and an end of a last OFDM symbol in a previous slot of the second CC;
compare the measured RTD to one or more signaling metrics associated with the first and second CCs;
transmit, to the UE, first downlink (DL) signaling on the first CC and second DL signaling on the second CC, wherein one of the first DL signaling or second DL signaling comprises an adjusted set of OFDM symbols, and wherein the adjusted set of OFDM symbols is adjusted to avoid a degraded OFDM symbol and is at least partially based on the comparison of the measured RTD to the one or more signaling metrics.

24. The apparatus of claim 23, wherein the at least one processor is further configured to cause the network node to:
transmit, to the UE, signaling comprising an indication of an alignment of a shared low noise amplifier (LNA) with either the first CC or the second CC.

25. The apparatus of claim 23, wherein the at least one processor is further configured to cause the network node to:
configure, for reception of a physical downlink control channel (PDCCH), at least one control resource set (CORESET) located after a first OFDM symbol in at least one of the first CC or the second CC.

26. The apparatus of claim 23, wherein the comparison of the RTD to one or more signaling metrics comprises determining which one of the following inequalities is satisfied:
the measured RTD is less than a cyclic prefix (CP) which is less than X microseconds (μs), wherein X is value corresponding to a maximum receive timing difference (MRTD);
the CP is less than the measured RTD which is less than X μs; or
the measured RTD is greater than X μs.

27. The apparatus of claim 26, wherein:
if the measured RTD is less than the CP which is less than X μs, the at least one processor is further configured to cause the network node to schedule the adjusted PDSCH signaling within available symbols in a slot corresponding to a range between sym0 and sym13;
if the CP is less than the measured RTD which is less than X μs, the at least one processor is further configured to cause the network node to schedule the adjusted PDSCH signaling within available symbols in a slot except a first symbol or a last symbol corresponding respectively to one of a range between sym1-sym13 or sym0-sym12; or
if the measured RTD is greater than X μs, the at least one processor is further configured to cause the network node to refrain from scheduling the adjusted PDSCH signaling.

28. The apparatus of claim 23, wherein a maximum of four multiple input multiple output (MIMO) layers are supported on at least one of the first CC or the second CC.

29. A non-transitory computer readable storage medium storing program instructions executable by one or more processors to cause a user equipment (UE) to:
establish a cellular link with a network node;
transmit, to the network node, signaling including capability information indicating support of carrier aggregation (CA) of a first component carrier (CC) and a second CC;
receive, from the network node, physical downlink shared channel (PDSCH) signaling on the first and second CCs;
measure a relative time difference (RTD) between at least one of the following associated with the PDSCH signaling:
a start of a first orthogonal frequency division multiplex (OFDM) symbol in a current slot of the first CC and a start of a first OFDM symbol in a current slot of the second CC, or
a start of a first OFDM symbol in a current slot of the first CC and an end of a last OFDM symbol in a previous slot of the second CC;
transmit, to the network node, a report comprising the measured RTD; and
receive, from the network node, first downlink (DL) signaling on the first CC and second DL signaling on the second CC, wherein one of the first DL signaling or second DL signaling comprises an adjusted set of OFDM symbols, and wherein the adjusted set of OFDM symbols is adjusted at least partially based on the measured RTD such that a degraded OFDM symbol is avoided.

30. The non-transitory computer readable storage medium of claim 29, wherein the program instructions are further executable to cause the UE to:
determine a measurement reference point of the first CC or the second CC, wherein the measurement reference point corresponds to a CC which is the other of the one of the first CC or second CC associated with the adjusted set of OFDM symbols.
